(19) United States
(12) Patent Application Publication
(10) Pub. No.: US 2009/0063821 A1
(43) Pub. Date: Mar. 5, 2009

(54) PROCESSOR APPARATUS INCLUDING OPERATION CONTROLLER PROVIDED BETWEEN DECODE STAGE AND EXECUTE STAGE

(75) Inventor: Masami NAKAJIMA, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/198,480

(22) Filed: Aug. 26, 2008

(30) Foreign Application Priority Data
Aug. 28, 2007 (JP) 2007-221030
Jul. 28, 2008 (JP) 2008-193571

(51) Int. Cl. G06F 9/30

(52) U.S. Cl. 712/208; 712/E09.016

(57) ABSTRACT

A processor apparatus includes a sequence controller that decodes the instruction code stored in an instruction memory, an operation array that executes operation of the decoded instruction code, and an asynchronous FIFO. The asynchronous FIFO is provided between a decode stage for decoding the instruction code into at least one instruction by the sequence controller and an execute stage for executing the decoded instruction by the operation array. The asynchronous FIFO executes control, so that the read timing and the execute timing of the decoded instruction are different from each other, and the decoded instruction is continuously executed by the operation array.

### BACKGROUND OF THE INVENTION

1. Field of the Invention

The present invention relates to processor apparatus, and, in particular, to a large-scaled processor apparatus that carries out data processing for a very large memory.

2. Description of the Related Art

Recently, in accordance with the popularization of portable terminal equipment, there has been a growing importance of digital signal processing for processing a large amount of audio data and image data at high speed. Generally speaking, a DSP (Digital Signal Processor) is used as a special semiconductor apparatus for the digital signal processing. When the amount of data to be processed is very large, the processing time can be shortened by carrying out parallel operation for simultaneously operating a plurality of computing units. In particular, when introduction operation is carried out for a plurality of pieces of data, the area of the computing units can be reduced with keeping high parallelism by using a SIMD (Single Instruction stream Multiple Data stream) system and providing a controller that controls the processing by interpreting instructions common to a plurality of data processors. Moreover, when the amount of data to be processed is large and a very large amount of addition or multiplication operations are carried out, the performance per area is further improved when the addition operation is carried out by bit serial operation (a method of dividing one piece of data into a plurality of portions and carrying out operation sequentially for them). Therefore, it is desired to use the SIMD system based on 1-bit or 2-bit serial operation. As described above, in the large-scaled SIMD processor that has a large-capacity SRAM whose data processing speed accompanied by data memory access becomes important, a plurality of operation arrays are controlled by one controller. Therefore, the ratio of the area of the operation array to the area of the entire processor is large, and the performance per area of the processor or the performance per power consumption can be improved. Such a SIMD computing unit is described in Patent Document 1. Prior art documents related to the present invention are as follows:

Patent Document 1: Japanese patent laid-open publication No. JP-06-096240-A;

Patent Document 2: Japanese patent laid-open publication No. JP-09-022379-A; and

Patent Document 3: U.S. Pat. No. 7,069,423.

FIG. 23 is a pipeline chart showing a configuration of a processing part of a super-parallel SIMD processor that the inventor has examined. Referring to FIG. 23, an instruction code is fetched in an instruction memory 10 in an instruction fetch (hereinafter referred to as IF) stage. In a decode stage and execute control processing by a sequence controller 100, the instruction code read out from the instruction memory 10 via a flip-flop (hereinafter referred to as FF) 11 is decoded into an instruction in a form which can be processed by the sequence controller 100 by carrying out prescribed processing P1. The decoded instruction is outputted to a register 13 and an arithmetic logic unit (hereinafter referred to as ALU) 14 and outputted to a register 15 and an ALU 16 via an FF 102. The register 13 and the ALU 14 carry out arithmetic processing on the basis of the inputted instruction. Moreover, in execute stage processing by an operation array 101 configured by including a plurality of processing elements (PEs), the register 15 and the ALU 16 carry out arithmetic processing on the basis of the inputted instruction.

In this case, the concrete contents of instructions to the sequence controller 100 are shown below.

### (A) Instructions to Control the Sequence Controller 100:

(a) sequence control including a loop;

(b) generation of an interrupt signal including DMA startup; and

(c) generation of pointers for the operation array 101.

### (B) Instructions to Control the Operation Array 101:

(a) Issue of instructions and pointers for the operation array 101.

It is noted that both “the instructions to control the sequence controller 100” and “the instructions to control the operation array 101” include an instruction that needs a plurality of cycles for execution. Therefore, with regard to the instruction format, the instructions permit the following combinations:

(a) parallel operation of “the instructions to control the sequence controller 100” and “the instructions to control the operation array 101”;

(b) single operation of “the instructions to control the sequence controller 100”; and

(c) single operation of “the instructions to control the operation array 101”.

When “the instructions to control the sequence controller 100” is executed by the SIMD processor, the operation array 101 is not executed by this case, as is apparent from FIG. 24, a time interval (spare time) during which no instruction is executed by the operation array 101 appears. This therefore has led to a problem that the operating rate of the operation array 101 is reduced and the performance per unit area is lowered in the processor chip. Concretely, in a super-parallel SIMD processor MX-1 developed by Renesas technology Corporation, the operating rates of a FIR (Finite Impulse Response) filter and a median filter were 74% and 50%, respectively.

In order to improve the performance per unit area of the operation array 101, it is effective to increase the operating frequency of the processor. However, it is difficult to make an access to a large-scaled memory in a large-scaled processor because much time is required. Accordingly, a method of improving the operating frequency of the processor can be considered by providing a hierarchized memory of a combination of a memory that has a large scale and low speed and a memory that has a small scale and high speed (See FIG. 25) and using the memory that has a small scale and high speed near the processor. However, this case needs a plurality of memories and needs a pipeline register inserted since it is necessary for the operation array 101 to operate at a high operating frequency, and this leads to increase in the area and the power consumption of the entire processor.

Moreover, Patent Documents 2 and 3 each disclose a microcomputer (or a microprocessor) in which a DSP engine is mounted on one LSI together with a CPU core, and the microcomputer had problems similar to those of the SIMD processor described above.

### SUMMARY OF THE INVENTION

An object of the present invention is to solve the above problems and provide a processor apparatus capable of improving the operating rate of the operation part of the operation array and so on almost without increasing the area and power consumption.

In order to achieve the aforementioned objective, according to one aspect of the present invention, there is provided a processor apparatus including a sequence controller for decoding an instruction code stored in an instruction memory, and an operation part for executing operation of the decoded instruction code. The processor unit further includes an operation controller provided between a decode stage for decoding the instruction code into at least one instruction by the sequence controller and an execute stage for executing the decoded instruction by the operation part. The operation controller executes control, so that a read timing and an execute timing of the decoded instruction are different from each other, and the decoded instruction is continuously executed by the operation part.

In the above-mentioned processor apparatus, the operation controller includes an asynchronous FIFO which is set so that an operating frequency of the sequence controller becomes higher than an operating frequency of the operation part.

In addition, in the above-mentioned processor apparatus, the operation controller comprises a memory, the sequence controller temporarily stores the decoded instruction into the memory, and the operation part continuously reads out and executes the instruction stored in the memory.

Further, the above-mentioned processor apparatus further includes a direct memory access controller for transferring the instruction stored in the memory to the operation part by a direct memory access, and the sequence controller, the operation part, the direct memory access controller and the memory are connected via a bus with each other.

Furthermore, in the above-mentioned processor apparatus, the operation controller includes a FIFO for inputting a plurality of decoded instructions in one cycle, and outputting the inputted instructions sequentially continuously to the operation part.

Still further, in the above-mentioned processor apparatus, the operation controller comprises a programmable logic controller for generating a plurality of instructions on the basis of the decoded instruction, and outputting the generated instructions sequentially and continuously to the operation part. In this case, the programmable logic controller is a sequencer.

In addition, in the above-mentioned processor apparatus, the processor apparatus is a SIMD processor apparatus. The operation part may be a data path portion of a CPU. The operation part may be a digital signal processor (DSP). The operation part is a plurality of processing elements (PEs).

According to the processor apparatus of the invention, the processor apparatus includes the sequence controller that decodes the instruction code stored in the instruction memory and the operation part that executes operation of the decoded instruction code, and further includes the operation controller provided between the decode stage for decoding the instruction code into at least one instruction by the sequence controller and the execute stage for executing the decoded instruction by the operation part. The operation controller executes control, so that the read timing and the execute timing of the decoded instruction are different from each other, and the decoded instruction is continuously executed by the operation part. In this case, the operation controller such as an asynchronous FIFO is provided between the sequence controller and the operation part of the processor apparatus, and carrying out parallel operation of the sequence controller and the operation part. Then the operating rate of the operation part is thereby increased, and the performance of the entire processor apparatus can be improved by reducing the number of execute cycles. In particular, in a large-scaled SIMD processor apparatus, the operation part is a large-scaled operation array, and the area in the processor apparatus is dominant. It is an extremely important problem to improve the operating rate of the operation array.

In this case, when the frequency of the sequence controller is made to be higher than that of the operation part, it becomes possible to improve the operating rate of the operation part by setting the frequency of the sequence controller to be faster than that of the operation part of FIG. 4. In this case, the FIFO provided between the sequence controller and the operation part is an asynchronous FIFO. In this case, the area of the sequence controller has a smaller ratio than that of the entire processor apparatus. Therefore, the improvement in the power consumption of the sequence controller in accordance with the frequency increase exerts a smaller influence than the improvement in the performance of the processor.

Moreover, when a plurality of cycles is required for the operation part's execution of a processing in accordance to the instruction, it becomes possible to carry out parallel operation of the sequence controller and the operation part as shown in FIG. 19. The cycle of the execution singly by the sequence controller is reduced, and the operating rate of the operation part is improved. As a result, the number of execute cycles can be reduced, and the performance of the processor can be also improved. In concrete, when the invention was applied to the super-parallel SIMD processor MX-1 developed by Renesas technology Corporation, the performances of the FIR filter and the median filter were able to be improved by 1.35 times and 1.5 times, respectively.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram showing a configuration of a SIMD processor 200 according to a first preferred embodiment of the invention;

FIG. 2 is a block diagram showing a detailed configuration of the portions of a sequence controller 20, an asynchronous FIFO 12 and an operation array 21 in the SIMD processor 200 of FIG. 1;

FIG. 3 is a pipeline chart showing a configuration of a processing part of the SIMD processor 200 of FIG. 1;

FIG. 4 is a sequence chart showing instruction processing in the SIMD processor 200 of FIG. 1;

FIG. 5 is a block diagram showing a configuration of a SIMD processor 200A according to a second preferred embodiment of the invention;

FIG. 6 is a pipeline chart showing a configuration of a processing part of the SIMD processor 200A of FIG. 5;

FIG. 7 is a sequence chart showing instruction processing in the SIMD processor 200A of FIG. 5;

FIG. 8 is a block diagram showing a configuration of a SIMD processor 200B according to a third preferred embodiment of the invention;

FIG. 9 is a block diagram showing a configuration of a SIMD processor 200C according to a fourth preferred embodiment of the invention;

FIG. 10 is a pipeline chart showing a configuration of a processing part of the SIMD processor 200C of FIG. 9;

FIG. 11 is a sequence chart showing instruction processing in the SIMD processor 200C of FIG. 9;

FIG. 12 is a pipeline chart showing a configuration of a processing part of a SIMD processor according to a fifth preferred embodiment of the invention;

FIG. 13 is a pipeline chart showing a configuration of a processing part of a SIMD processor according to a sixth preferred embodiment of the invention;

FIG. 14 is a sequence chart showing instruction processing in the SIMD processor of FIG. 13;

FIG. 15 is a block diagram showing a configuration of a processor according to a seventh preferred embodiment of the invention;

FIG. 16 is a pipeline chart showing a configuration of a processing part of the processor of FIG. 15;

FIG. 17 is a pipeline chart showing a configuration of a processing part of a processor according to an eighth preferred embodiment of the invention;

FIG. 18 is a pipeline chart showing a configuration of a processing part of a processor according to a ninth preferred embodiment of the invention;

FIG. 19 is a pipeline chart showing a configuration of a processing part of a processor according to a tenth preferred embodiment of the invention;

FIG. 20 is a sequence chart showing instruction processing in a processor apparatus according to the invention;

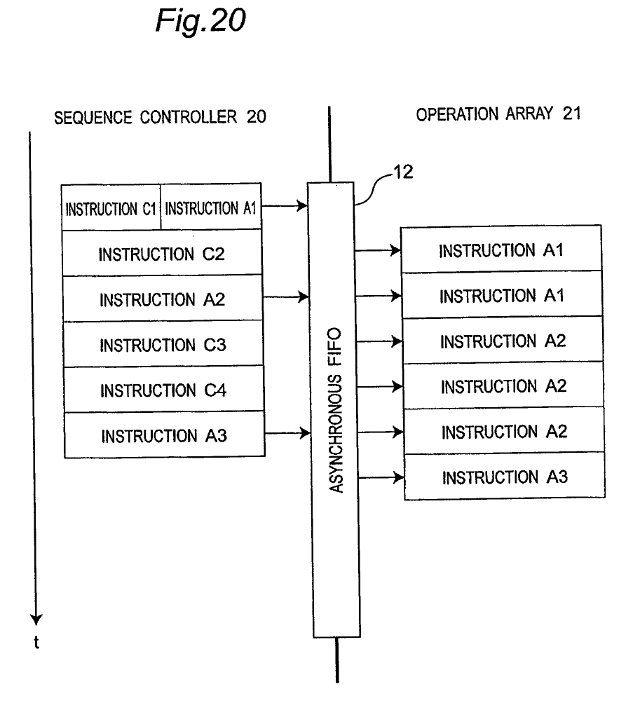

FIG. 21 is a block diagram showing a configuration of a processor 300 according to an eleventh preferred embodiment of the invention;

FIG. 22 is a block diagram showing a configuration of a processor 300A according to a twelfth preferred embodiment of the invention;

FIG. 23 is a pipeline chart showing a configuration of a processing part of a prior art super-parallel SIMD processor;

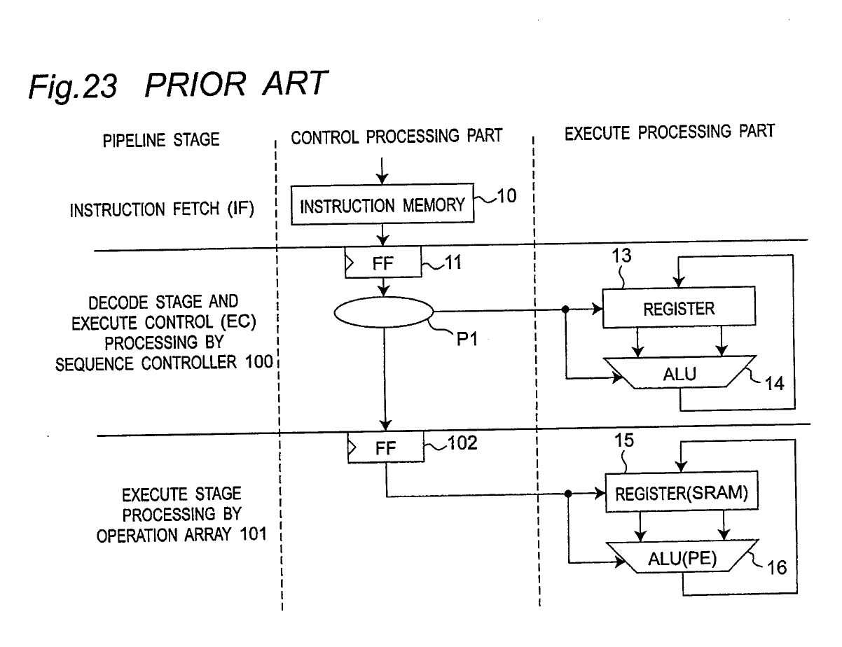

FIG. 24 is a sequence chart showing instruction processing in the super-parallel SIMD processor of FIG. 23; and

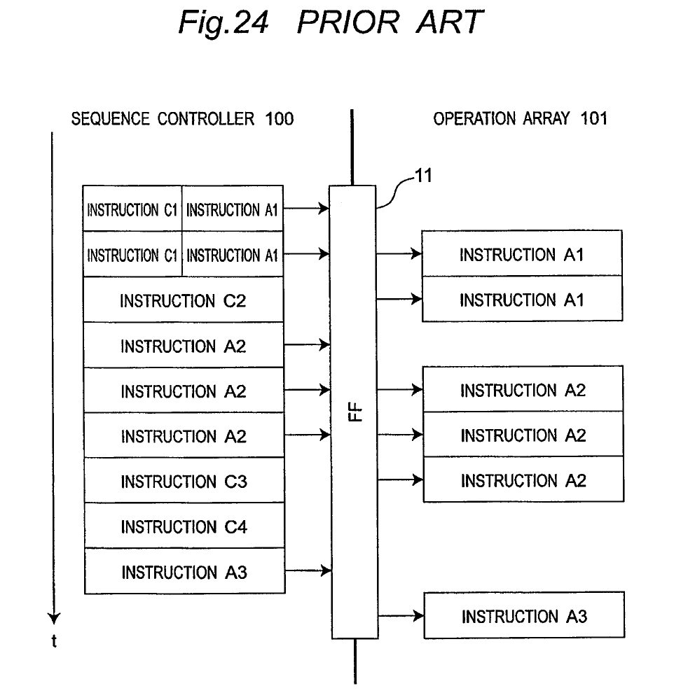

FIG. 25 is a hierarchy diagram showing a relation of the clock frequency to the memory capacity indicating the hierarchy of a prior art memory.

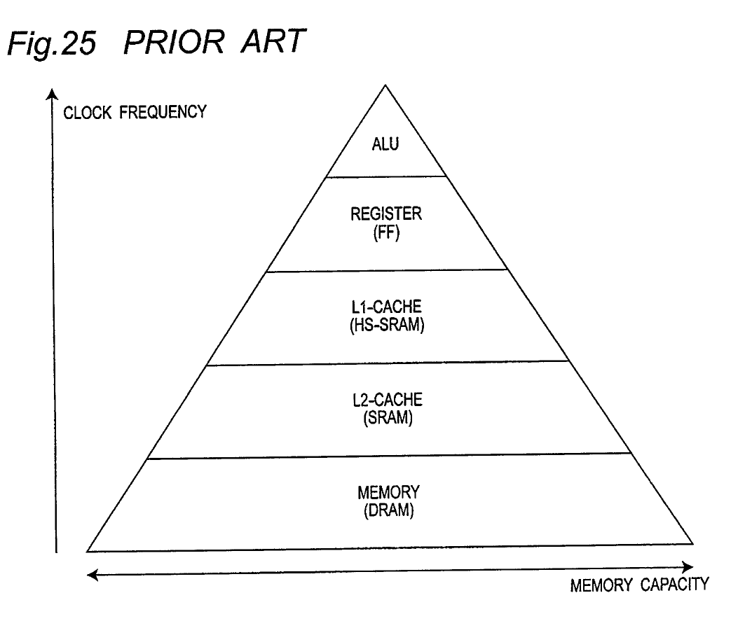

### DETAILED DESCRIPTION OF THE PREFERRED EMBODIMENTS

Preferred embodiments of the present invention will be described below with reference to the drawings. In the following embodiments, like components are designated by like reference numerals.

### First Preferred Embodiment

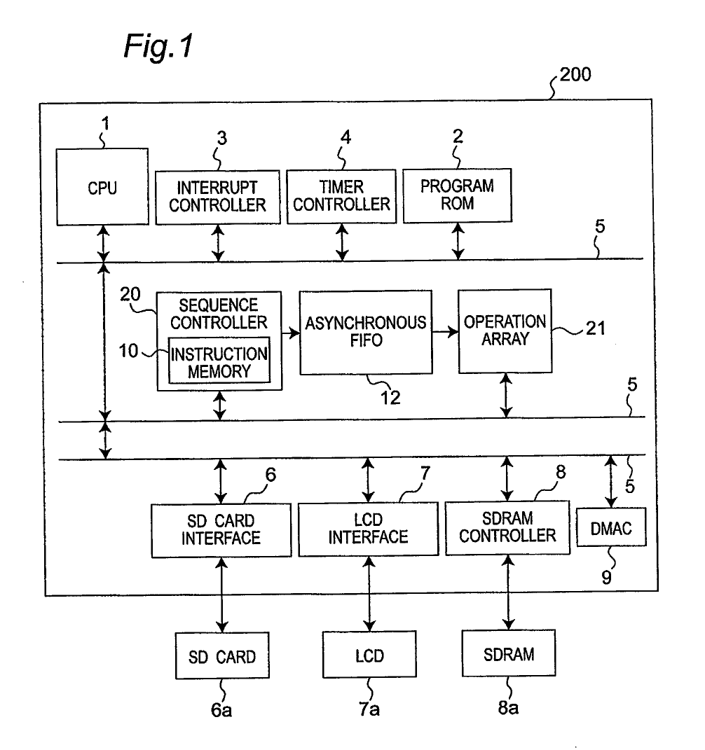

FIG. 1 is a block diagram showing a configuration of a SIMD processor 200 according to the first preferred embodiment of the invention. The SIMD processor 200 of FIG. 1 is a large-scaled SIMD processor having an operation array 21 including a large-capacity SRAM. The SIMD processor is configured such that A CPU 1 that carries out processing of prescribed operation, control and so on, a program ROM 2 that stores a program to be executed by the CPU 1, an interrupt controller 3 that carries out interrupt control to the CPU 1, a timer controller 4 that carries out time management of the CPU 1, a sequence controller 20 that includes an instruction memory 10, an operation array 21, an SD (Secure Digital) card interface 6, an LCD (Liquid Crystal Display) interface 7, an SDRAM (Synchronous Dynamic RAM) controller 8, and a direct memory access controller (hereinafter referred to as DMAC (Direct Memory Access Controller)) 9 are connected via a bus 5 with each other. In this case, the SIMD processor 200 of FIG. 1 is particularly characterized in that an asynchronous FIFO (First-In First-Out) memory (FIFO memory is hereinafter referred to as FIFO) 12 is inserted between the sequence controller 20 and the operation array 21.

An SD card 6a is connected to the SD card interface 6, an LCD 7a is connected to the LCD interface 7, and an SDRAM 8a is connected to the SDRAM interface 8. It is noted that the DMAC 9 is a controller for transferring data in the processor 200 to the SDRAM 8a.

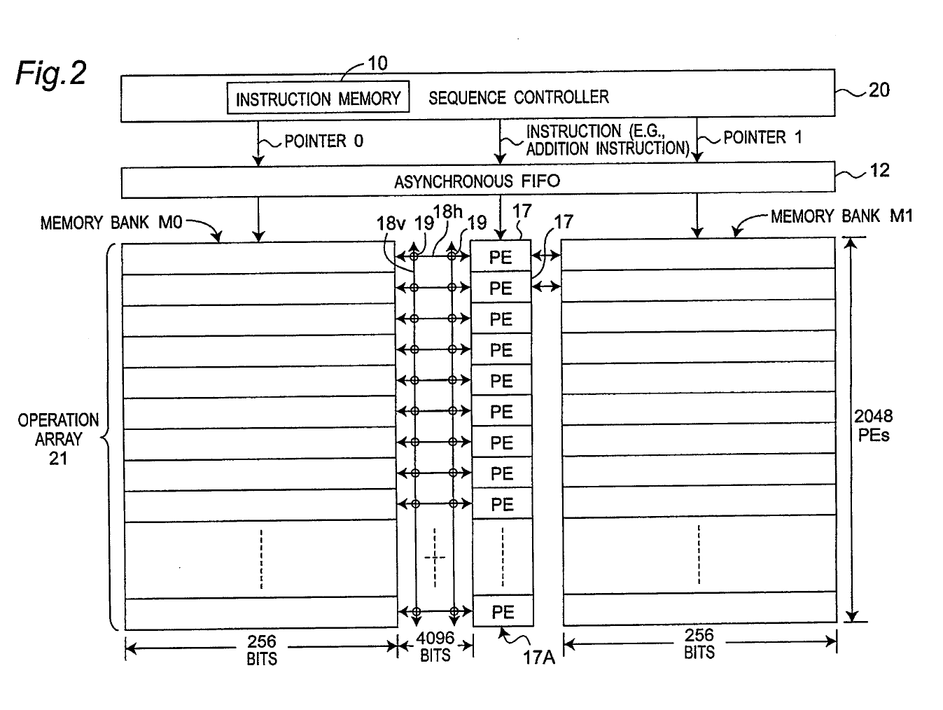

FIG. 2 is a block diagram showing a detailed configuration of the portions of the sequence controller 20, the asynchronous FIFO 12 and the operation array 21 in the super-parallel SIMD processor 200 of FIG. 1. Referring to FIG. 2, the asynchronous FIFO 12 is provided inserted between the sequence controller 20 and the operation array 21. The operation array 21 is configured by including a large-capacity single-port SRAM that is used as a data register, and is divided into two memory banks M0 and M1, a PE array 17A configured by including, for example, 2048 2-bit processing elements (hereinafter referred to as PEs) 17, 2048 horizontal channel buses 18h connected between the memory bank M0 and the PE array 17A, 4096 vertical channel buses 18v for interconnecting the PEs, and a switch transistor 19 provided at each of the intersections of the horizontal channel buses 18h and the vertical channel buses 18v. In this case, the horizontal channel buses 18h are connection paths for data transfer between the PEs 17 and the data register and serve as the fundamental path of operation. The data transfer via the horizontal channel buses 18h has no mutual interference, and is carried out by one clock. Moreover, the vertical channel buses 18v are connection paths for data transfer between PE 17 and PE 17, and is capable of carrying out data transfer in parallel between PE 17 and PE 17 located at a certain distance and processing butterfly operation, which is frequently used for digital signal processing operation via the data transfer paths, with higher efficiency.

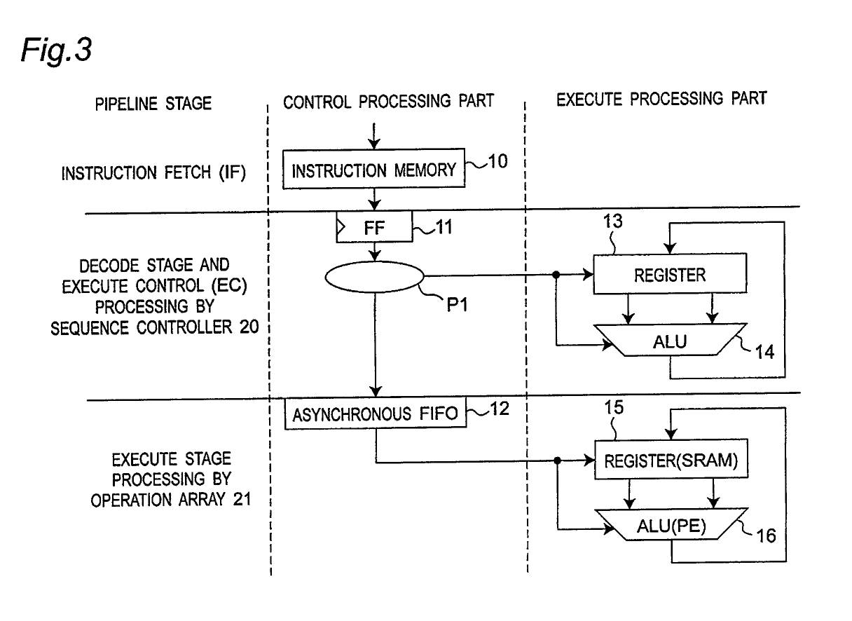

FIG. 3 is a pipeline chart showing a configuration of a processing part of the SIMD processor 200 of FIG. 1. The processing part is configured by including the sequence controller 20 with the instruction memory 10 and the FF 11, the operation array 21 including the plurality of ALUs 14 and 16 and the registers 13 and 15, and the asynchronous FIFO 12. The register 15 corresponds to an SRAM, and the ALU 16 corresponds to a PE. In this case, the instruction memory 10, the FF 11 and the asynchronous FIFO 12 constitute a control processing part, while the registers 13 and 15 and ALUs 14 and 16 constitute an execute processing part for carrying out arithmetic processing.

In the IF stage, an instruction code is fetched to the instruction memory 10. In a decode stage and execute control processing by the sequence controller 20, the instruction code read out from the instruction memory 10 via the FF 11 is decoded into an instruction which can be processed by the sequence controller 20 by carrying out prescribed processing P1, and it is determined whether the instruction is the instruction to control the sequence controller 20 or the instruction to control the operation array 21. The instruction is outputted to the register 13 and the ALU 14 when it should be operated by the sequence controller 20, or the instruction is outputted to the register 15 and the ALU 16 via the asynchronous FIFO 12 when it should be operated by the operation array 21. The register 13 and the ALU 14 carry out arithmetic processing of addition, multiplication and the like on the basis of the inputted instruction. In the execute stage processing by the operation array 21, the register 15 and the ALU 16 carry out arithmetic processing of addition, multiplication and the like on the basis of the inputted instruction. In the present preferred embodiment, it is possible to simultaneously operate the sequence controller 20 and the operation array 21.

The asynchronous FIFO 12 is provided between the sequence controller 20 and the operation array 21, and is configured by including a multi-stage flip-flop. In the asynchronous FIFO 12, it is set that the operating frequency of the sequence controller 20 becomes higher than the operating frequency of the operation array 21. The number of stages of the asynchronous FIFO 12 is determined according to the application to be applied depending on a relation between the supply of instructions to the operation array 21 and the consumption of instructions in the operation array 21 so that the sequence controller 20 and the operation array 21 operate most efficiently. It is appropriate that the number of stages should be generally equal to or larger than two stages, and preferably be four to eight stages. The instruction inputted to the asynchronous FIFO 12 is delayed by the number of cycles corresponding to the number of stages of the flip-flop that constitutes the asynchronous FIFO 12 and thereafter outputted to the register 15 and the ALU 16 by the First-In First-Out (FIFO) system.

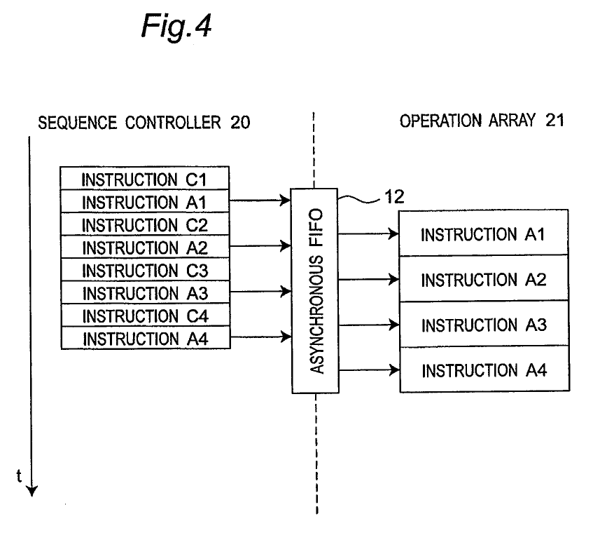

FIG. 4 is a sequence chart showing instruction processing in the SIMD processor 200 of FIG. 1. The operation of the SIMD processor 200 includes the two types of operation relevant to “instructions (instructions C1, C2, . . . ) to control the sequence controller 20” and action or operation relevant to “instructions (instructions A1, A2, . . . ) to control the operation array 21”. It is only “the instructions (instructions A1, A2, . . . ) to control the operation array 21” when the instruction is supplied from the sequence controller 20 to the operation array 21. Therefore, the instruction is not always supplied from the sequence controller 20 to the operation array 21 every cycle. In this case, the operating frequency of the sequence controller 20 is set to be higher than the operating frequency of the operation array 21 in the asynchronous FIFO 12, and therefore, it is controlled so that the supply of instructions to the operation array 21 and the consumption of instructions in the operation array 21 per cycle are made equivalent to each other and the instructions are continuously executed by the operation array 21. By this operation, the operating rate of the operation array 21 can be made higher than that of the prior art. The ratio of the area of the sequence controller 20 to the entire processor is small, and the power consumption of the sequence controller 20 is not dominant. Accordingly, this leads to little increase in the power consumption of the entire processor by setting the operating frequency of the sequence controller 20 to be higher.

In concrete, when the processor of the present preferred embodiment was applied to the super-parallel SIMD processor MX-1 developed by Renesas technology Corporation, the operating rates of the FIR filter and the median filter became 1.35 times and 1.5 times, respectively.

As described above, according to the processor of the present preferred embodiment, by providing the asynchronous FIFO 12 between the sequence controller 20 and the operation array 21 and setting the operating frequency of the sequence controller 20 to be higher than the operating frequency of the operation array 21, the number of cycles of the single operation of the sequence controller 20 can be reduced, and the operating rate of the operation array 21 can be improved as compared with that of the prior art. By improving the operating rate of the operation array 21, the arithmetic processing can be increased in speed as compared with that of the prior art.

Although the asynchronous FIFO 12 is configured by including, for example, the flip-flop in the above preferred embodiment, the invention is not limited to this, and it may be constituted of a dual-port memory.

### Second Preferred Embodiment

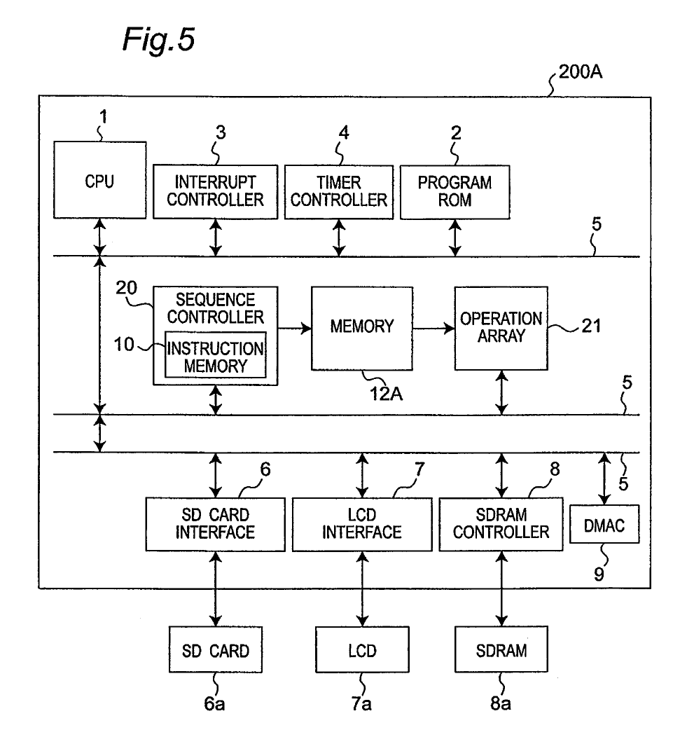

FIG. 5 is a block diagram showing a configuration of a SIMD processor 200A according to the second preferred embodiment of the invention. Referring to FIG. 5, such a point of difference resides that a memory 12A is provided in place of the asynchronous FIFO 12 as compared with the processor 200 of the first preferred embodiment shown in FIG. 1. The other points are similar to those of the processor 200 of the first preferred embodiment shown in FIG. 1, and no reiterative explanation is provided for the components denoted by the same reference numerals.

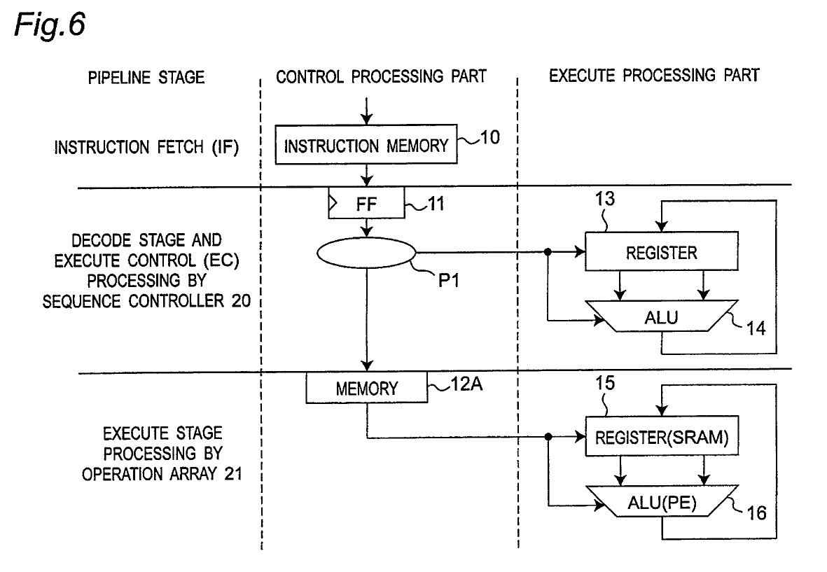

FIG. 6 is a pipeline chart showing a configuration of a processing part of the SIMD processor 200A of FIG. 5. Referring to FIG. 6, a memory 12A is, for example, a single-port memory, and temporarily stores the decoded instruction by the sequence controller 20 before executing the application. The instructions stored in the memory 12A are sequentially read out and executed by the operation array 21 at the time of executing the application. By this operation, the decode processing of the sequence controller 20 at the time of executing the application can be simplified, and the operation array 21 can continuously execute the instructions every cycle. In the present preferred embodiment, the sequence controller 20 and the operation array 21 cannot simultaneously operate unlike the first preferred embodiment.

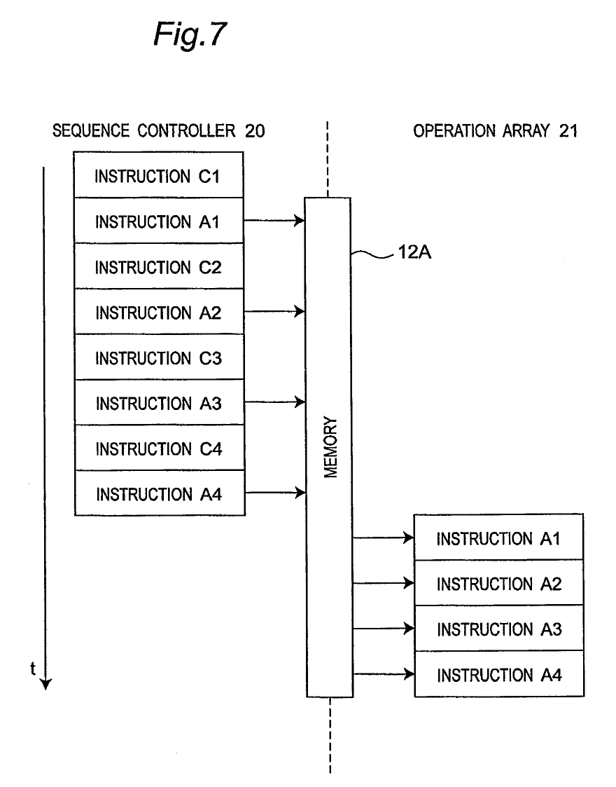

FIG. 7 is a sequence chart showing instruction processing in the SIMD processor 200A of FIG. 5. Referring to FIG. 7, the sequence controller 20 temporarily stores the instructions A1, A2, . . . to control the operation array 21 into the memory 12A before executing the application. The operation array 21 sequentially continuously reads out and executes the instructions A1, A2, . . . as stored in the memory 12A at the time of executing the application.

As described above, according to the processor of the present preferred embodiment, the memory 12A is provided between the sequence controller 20 and the operation array 21, the instructions A1, A2, . . . are temporarily stored into the memory 12A by the sequence controller 20 before executing the application, and the stored instructions A1, A2, . . . are read out and executed by the operation array 21 at the time of executing the application. Therefore, the number of cycles of the single operation of the sequence controller 20 can be reduced. With this arrangement, the operation array 21 can continuously process the instructions, and the operating rate of the operation array 21 can be improved as compared with that of the prior art.

### Third Preferred Embodiment

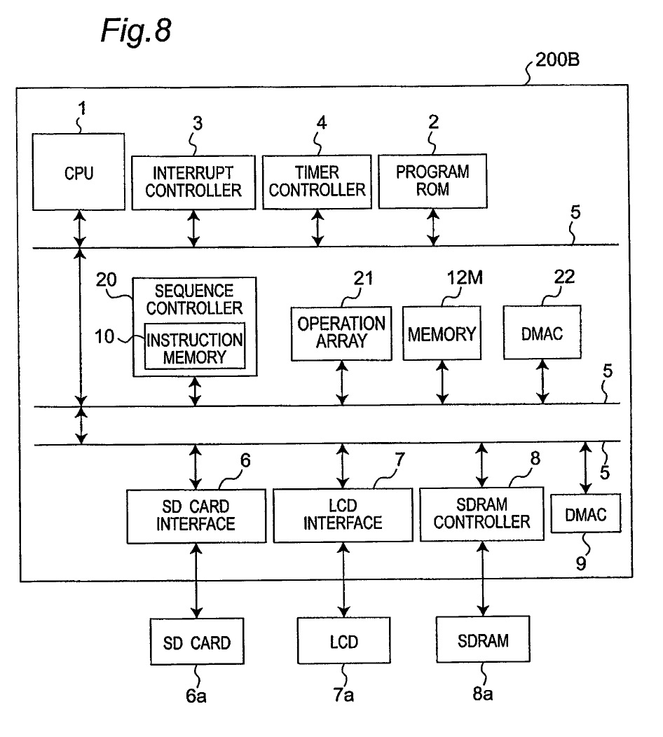

FIG. 8 is a block diagram showing a configuration of a SIMD processor 200B according to the third preferred embodiment of the invention. Referring to FIG. 8, the processor of the present preferred embodiment is different from the processor 200A of the second preferred embodiment shown in FIG. 5, in that a memory 12M is provided in place of the memory 12A, a direct memory access controller (hereinafter referred to as DMAC (Direct Memory Access Controller)) 22 is further provided, and the sequence controller 20, the operation array 21, the memory 12M and the DMAC 22 are connected via a bus 5 with each other. The other points are similar to those of the processor 200A of the second preferred embodiment shown in FIG. 5, and no reiterative explanation is provided for the components denoted by the same reference numerals.

The sequence controller 20 temporarily stores the instructions A1, A2, . . . to control the operation array 21 into the memory 12A via the bus 5 before executing the application. At the time of executing the application, the DMAC 22 transfers the instruction stored in the memory 12A to the operation array 21 via the bus 5 by direct memory access (DMA). By this operation, the transfer of the instruction to the operation array 21 can be increased in speed.

As described above, according to the processor of the present preferred embodiment, the DMAC 22 is further provided, and the sequence controller 20, the operation array 21, the memory 12M and the DMAC 22 are connected via the bus 5 with each other. Therefore, the transfer of the instruction to the operation array 21 can be increased in speed as compared with the processor of the second preferred embodiment. Moreover, by holding the decoded data in the memory 12M, the instruction can be issued every cycle, and the number of cycles of the single operation of the sequence controller 20 is reduced, and this leads to increase in the operating rate of the operation array 21.

### Fourth Preferred Embodiment

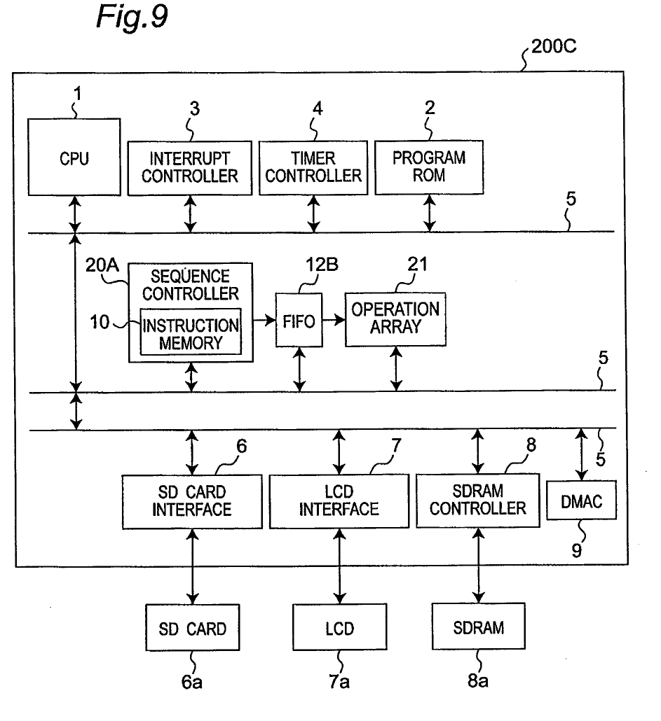

FIG. 9 is a block diagram showing a configuration of a SIMD processor 200C according to the fourth preferred embodiment of the invention. Referring to FIG. 9, such a point of difference resides that a sequence controller 20A is provided in place of the sequence controller 20, and a FIFO 12B is provided in place of the asynchronous FIFO 12 as compared with the processor 200 of the first preferred embodiment shown in FIG. 1. The other points are similar to those of the processor 200 of the first preferred embodiment shown in FIG. 1, and no reiterative explanation is provided for the components denoted by the same reference numerals.

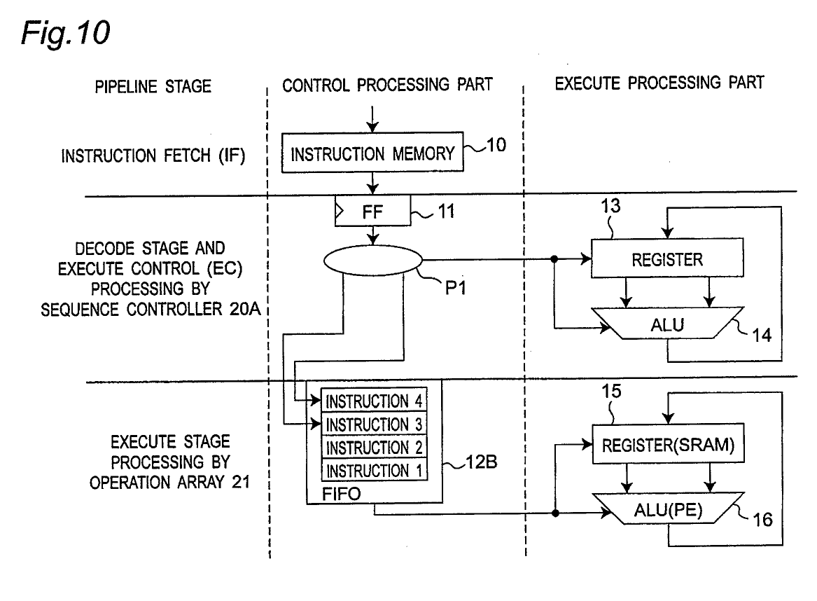

FIG. 10 is a pipeline chart showing a configuration of a processing part of the SIMD processor 200C of FIG. 9. Referring to FIG. 10, the sequence controller 20A is different from the sequence controller 20 of the first preferred embodiment only in that the decoded instructions are outputted two by two to the FIFO 12B. Moreover, the FIFO 12B is configured by including a four-stage flip-flop, and is able to input two instructions in one cycle. The instructions stored in the FIFO 12B are continuously supplied one by one to the register 15 and the ALU 16 by the FIFO system.

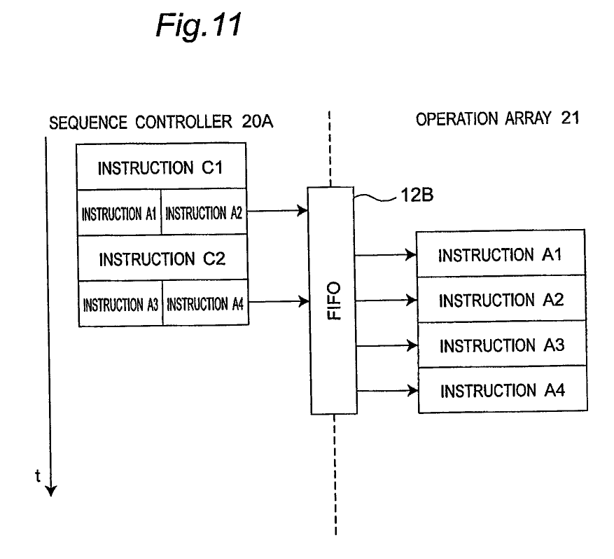

FIG. 11 is a sequence chart showing instruction processing in the SIMD processor of FIG. 9. Referring to FIG. 11, the FIFO 12B simultaneously inputs two instructions A1 and A2 to be operated in the operation array 21 and sequentially continuously outputs the inputted instructions one by one to the operation array 21. Therefore, even in the presence of instructions C1, C2, . . . to control the sequence controller 20A, the supply of instructions to the operation array 21 and the consumption of instructions in the operation array 21 can be made equivalent to each other.

As described above, according to the processor of the present preferred embodiment, the FIFO 12B capable of inputting two instructions in one cycle is provided between the sequence controller 20A and the operation array 21. Therefore, the number of cycles of the single operation of the sequence controller 20 can be reduced, while the operation array 21 can continuously process the instructions, and this leads to that the operating rate of the operation array 21 can be improved as compared with that of the prior art.

Although two instructions are inputted in one cycle to the FIFO 12B in the present preferred embodiment, the invention is not limited to this, and it may have such a configuration to input three or more instructions in one cycle. Moreover, although the FIFO 12B is configured by including the four-stage flip-flop, the invention is not limited to this, and it may have such a configuration as a multi-stage flip-flop of two or more stages.

### Fifth Preferred Embodiment

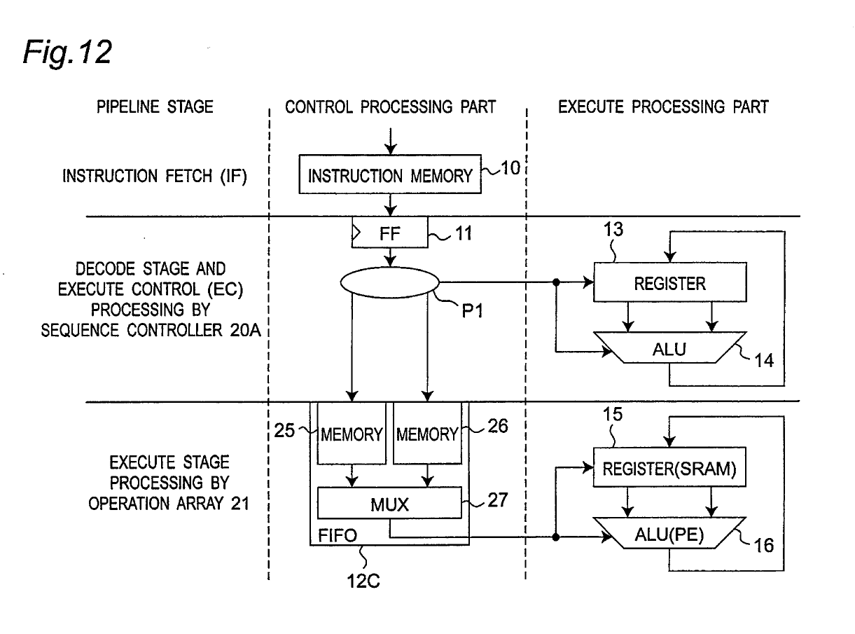

FIG. 12 is a pipeline chart showing a configuration of a processing part of a SIMD processor according to the fifth preferred embodiment of the invention. Referring to FIG. 12, such a point of difference resides that the sequence controller 20A is provided in place of the sequence controller 20, and a FIFO 12C is provided in place of the asynchronous FIFO 12, as compared with the processor 200 of the first preferred embodiment shown in FIG. 3. The other points are similar to those of the processor 200 of the first preferred embodiment shown in FIG. 1, and no reiterative explanation is provided for the components denoted by the same reference numerals.

Referring to FIG. 12, the sequence controller 20A is different from the sequence controller 20 of the first preferred embodiment only in that the decoded instructions are outputted two by two to the FIFO 12C. Moreover, the FIFO 12C is constituted of memories 25 and 26 that inputs via mutually different ports and a multiplexer 27. The FIFO 12C can inputs two instructions in one cycle by inputting the instructions to the memories 25 and 26 one by one in one cycle and continuously outputs the instructions one by one to the register 15 and the ALU 16 by the FIFO system by selecting either one of the memories 25 and 26 by the multiplexer 27.

As described above, according to the processor of the present preferred embodiment, the FIFO 12C capable of inputting two instructions in one cycle is provided between the sequence controller 20A and the operation array 21. Therefore, the number of cycles of the single operation of the sequence controller 20 can be reduced, while the operation array 21 can continuously process the instructions, and this leads to that the operating rate of the operation array 21 can be improved as compared with that of the prior art.

Although two instructions are inputted in one cycle by the FIFO 12C having the two memories 25 and 26 that inputs via mutually different ports in the present preferred embodiment, the invention is not limited to this, and it may have such a configuration that three or more memories that inputs via mutually different ports are provided and three or more instructions are inputted in one cycle.

### Sixth Preferred Embodiment

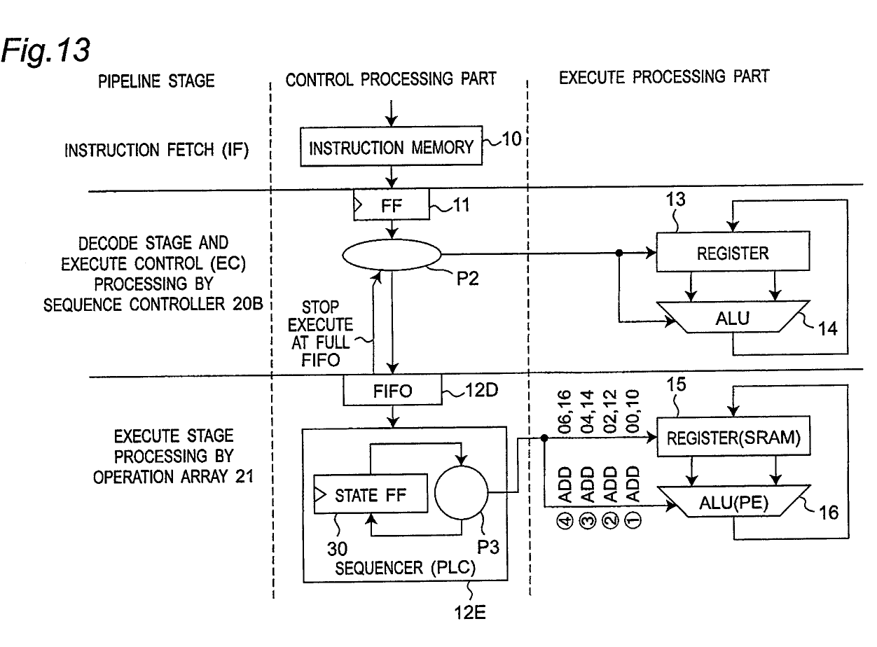

FIG. 13 is a pipeline chart showing a configuration of a processing part of a SIMD processor according to the sixth preferred embodiment of the invention. Referring to FIG. 13, such a point of difference resides that a sequence controller 20B is provided in place of the sequence controller 20, and a FIFO 12D and a sequencer 12E constituted of a programmable logic controller (hereinafter referred to as PLC) are provided in place of the asynchronous FIFO 12 as compared with the processor 200 of the first preferred embodiment shown in FIG. 1. The other points are similar to those of the processor 200 of the first preferred embodiment shown in FIG. 1, and no reiterative explanation is provided for the components denoted by the same reference numerals.

In a decode stage and execute control processing by the sequence controller 20B of FIG. 13, the instruction code read out from the instruction memory 10 via the FF 11 is decoded into an instruction in a form which can be processed by the sequence controller 20B by carrying out prescribed processing P2, and it is determined whether the instruction is the instruction to carry out control of the sequence controller 20B or the instruction to carry out control of the operation array 21. The instruction is outputted to the register 13 and the ALU 14 when it is to be operated by the sequence controller 20B, or a plurality of instructions are converted into one instruction in a form which can be processed by the sequencer 12E and thereafter outputted when the instructions are to be operated in the operation array 21. In this case, when the FIFO 12D is holding a prescribed number of instructions, a signal of “FIFO full” is outputted from the FIFO 12D to the sequence controller 20B. The FIFO 12D is in a memory full state while the signal is asserted, and no more instruction can be put from the sequence controller 20B into the FIFO 12D. In this case, the sequence controller 20B stops executing the processing P2 and puts no new instruction into the FIFO 12D.

The sequencer 12E is a state machine, which is configured by including, for example, a PLC and transits via, for example, a plurality of prescribed states according to prescribed conditions. In this case, the sequencer 12E is constituted of a combinational circuit of a state FF 30 that holds a state and a circuit for executing processing P3 to carry out control of the state machine and the generation of a signal to the operation part. By holding the current state by the state FF 30 in the sequencer 12E and executing the prescribed processing P3, control of the state of the sequencer 12E and generation of instructions to be outputted to the register 15 and the ALU 16 are carried out. The sequencer 12E generates a plurality of instructions on the basis of the instruction from the sequence controller 20B, and the generated instructions are continuously outputted to the register 15 and the ALU 16. Namely, the instruction issued from the sequence controller 20B is temporarily outputted to the FIFO 12D, and the instructions inputted to the FIFO 12D are outputted to the sequencer 12E in the order in which they are inputted. The sequencer 12E autonomously supplies instructions to the operation array 21 over a plurality of cycles according to the instructions supplied from the FIFO 12D. For example, in a case where the ALU 16 is a 2-bit computing unit, the sequencer 12E generates four ADD statements of two bits on the basis of the instruction A0 when the instruction A0 indicating the addition of eight bits is inputted from the sequence controller 20B, outputs “ADD” that represents the ADD statement to the ALU 16 over four cycles, and forms an output to the register 15 with incrementing the pointer that indicates the address where two value to be added are stored.

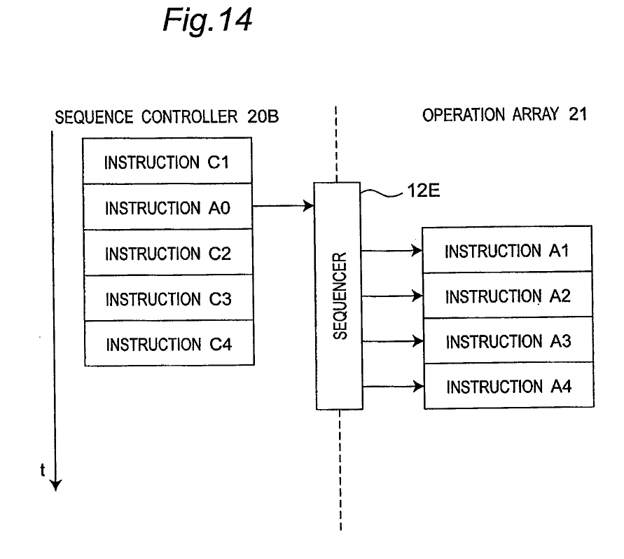

FIG. 14 is a sequence chart showing instruction processing in the SIMD processor of FIG. 13. Referring to FIG. 14, when the sequence controller 20B outputs the instruction A0 to the sequencer 12E, the sequencer 12E generates four instructions A1 to A4 on the basis of the instruction A0 and sequentially continuously outputs the instructions to the operation array 21. Therefore, the instructions are supplied from the sequencer 12E to the operation array 21 even when no instruction is supplied from the sequence controller 20B to the sequencer 12E.

As described above, according to the processor of the present preferred embodiment, the sequencer 12E is provided between the sequence controller 20B and the operation array 21, and the sequencer 12E generates the plurality of instructions based on the instruction supplied from the sequence controller 20B and supplies the instructions to the operation array 21. Therefore, the operation array 21 can continuously process the instructions, and the operating rate of the operation array 21 can be improved as compared with that of the prior art.

In other words, even if no instruction is supplied from the sequence controller 20B, an instruction can be supplied from the sequencer 12E to the operation array 21 every cycle. This allows the supply of the instruction to the operation array 21 per cycle and the consumption of the instruction in the operation array 21 to be made equivalent to each other even in the case of the “operation of only the sequence controller 20B”, making it possible to operate parallel the sequence controller 20B with the operation array 21 and to increase the operating rate of the operation array 21. It is noted that the sequence controller 20B and the operation array 21 can be simultaneously operated.

In the present preferred embodiment, the sequencer 12E itself supplies the instruction to the operation array 21, and the operation array 21 autonomously carries out the arithmetic processing over a plurality of cycles. Therefore, issue of the next processing of the operation array 21 and processing singly by the sequence controller 20B can be executed. The sequence controller 20B and the operation array 21 can operate in parallel, and the number of cycles of the single operation of the sequence controller 20B is reduced, and this leads to increase in the operating rate of the operation array 21.

### Seventh Preferred Embodiment

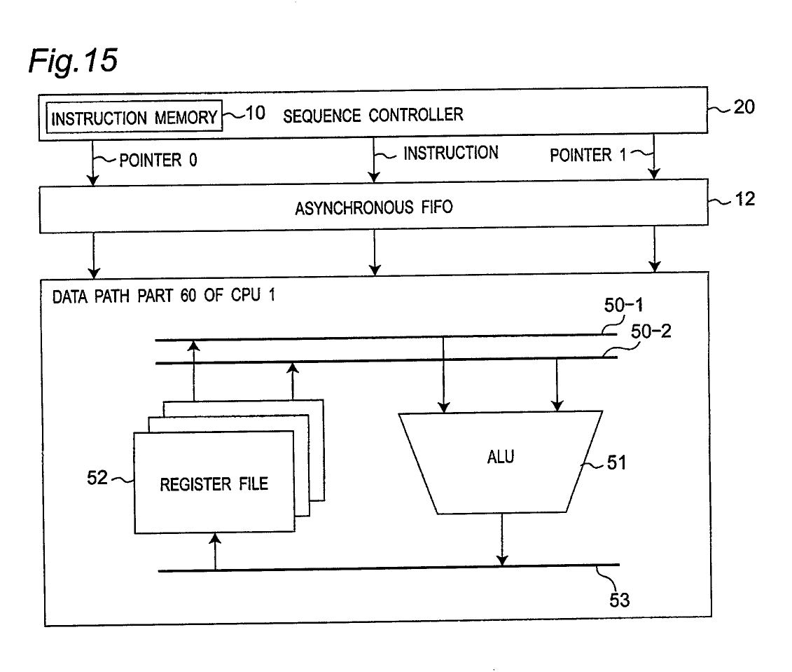

FIG. 15 is a block diagram showing a configuration of a processor according to the seventh preferred embodiment of the invention. Referring to FIG. 15, the processor is a microprocessor and has such a point of difference that a data path part 60 of the CPU 1 is provided in place of the operation array 21 as compared with the processor 200 of the first preferred embodiment shown in FIG. 1. The other points are similar to those of the processor 200 of the first preferred embodiment shown in FIG. 1, and no reiterative explanation is provided for the components denoted by the same reference numerals. It is noted that an ALU 51 of the data path part 60 of the CPU 1 is, for example, an arithmetic accelerator, which is provided by a code computing unit such as a sum-of-products computing unit, an FPU (Floating-Point Unit), a multiplier, a subtractor or the like.

Referring to FIG. 15, the data path part 60 of the CPU 1 is constituted of buses 50-1, 50-2 and 53, a plurality of register files 52, and an ALU 51. The register files 52 and the ALU 51 are connected via the buses 50-1, 50-2 and 53 with each other. The ALU 51 reads out the data of the register files 52 via the buses 50-1 and 50-2 on the basis of the pointer 0 and the pointer 1, respectively, inputted from the sequence controller 20 via the asynchronous FIFO 12, carries out arithmetic processing based on the instruction inputted from the sequence controller 20 via the asynchronous FIFO 12 for the read out data and thereafter writes data into the register files 52 via the bus 53.

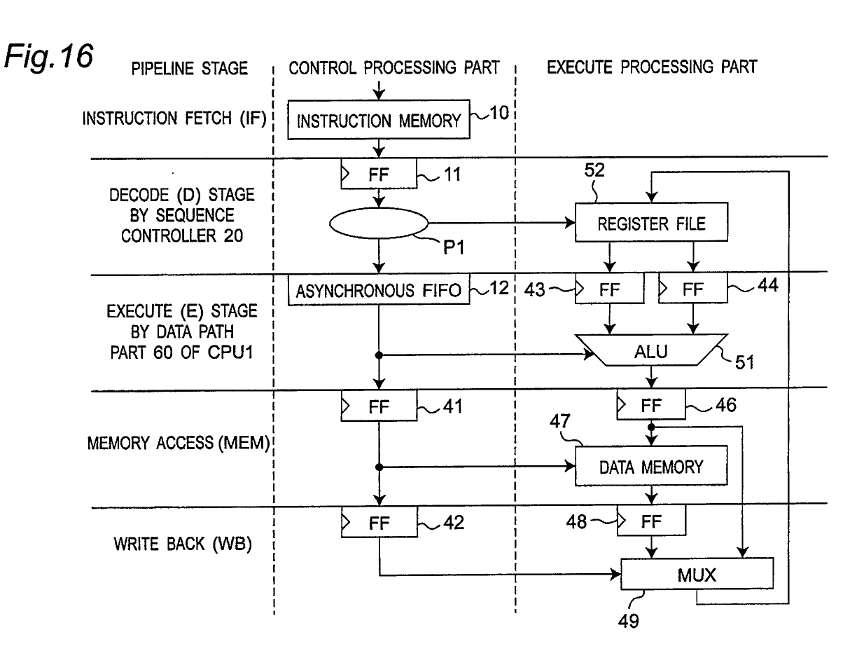

FIG. 16 is a pipeline chart showing a configuration of a processing part of the processor of FIG. 15. Referring to FIG. 16, an instruction code is fetched to the instruction memory 10 in the IF stage. In a decode (D) stage by the sequence controller 20, the instruction code is decoded into an instruction in a form which can be processed by the sequence controller 20 by carrying out the prescribed processing P1 of the instruction code read out from the instruction memory 10 via the FF 11, and the decoded instruction is outputted to the register file 52 and outputted to the ALU 51 via the asynchronous FIFO 12. In an execute (E) stage by the data path part 60 of the CPU 1, the data read out from the register files 52 via the FFs 43 and 44 are subjected to computing and address calculation on the basis of the instruction from the asynchronous FIFO 12 by the ALU 51. In a memory access (MEM) stage, an operand access is made in a data memory 47 on the basis of the computed result of the ALU 51 inputted via the FF 46 and the instruction inputted via the FF 41. In a write back (WB) stage, either one of the data fetched from the data memory 47 via an FF 48 and the computed result from the FF 46 is written into the register file 52 by selection by a MUX 49 on the basis of an instruction inputted via the FF 42.

As described above, according to the processor of the present preferred embodiment, by providing the asynchronous FIFO 12 between the sequence controller 20 and the data path part 60 of the CPU 1 and setting the operating frequency of the sequence controller 20 to be higher than the operating frequency of the data path part 60 of the CPU 1, the data path part 60 of the CPU 1 can continuously process the instructions, and the operating rate of the data path part 60 of the CPU 1 can be improved as compared with that of the prior art.

### Eighth Preferred Embodiment

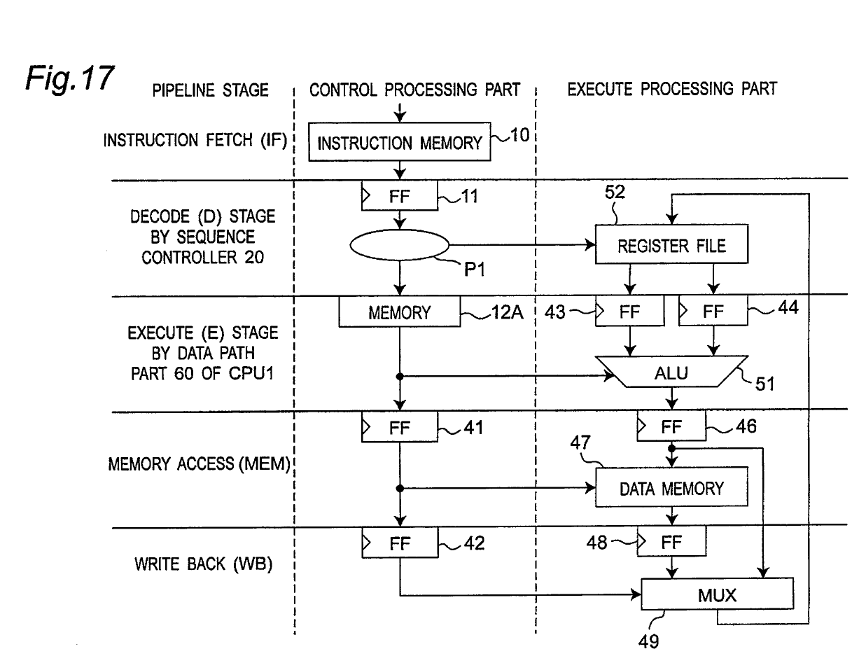

FIG. 17 is a pipeline chart showing a configuration of a processing part of a processor according to the eighth preferred embodiment of the invention. Referring to FIG. 17, such a point of difference resides that the memory 12A is provided in place of the asynchronous FIFO 12 as compared with the processor of the seventh preferred embodiment shown in FIG. 16. The other points are similar to those of the processor of the seventh preferred embodiment shown in FIG. 16, and no reiterative explanation is provided for the components denoted by the same reference numerals.

Referring to FIG. 17, the memory 12A has a configuration and action or operation similar to those of the memory 12A of the processor 200A of the second preferred embodiment shown in FIG. 6, and therefore, no description is provided therefor.

As described above, according to the processor of the present preferred embodiment, the memory 12A is provided between the sequence controller 20 and the data path part 60 of the CPU 1. The instructions A1, A2, . . . are preparatorily stored temporarily in the memory 12A by the sequence controller 20 before executing the application, and the stored instructions A1, A2, . . . are read out and executed by the data path part 60 of the CPU 1 at the time of executing the application. Therefore, the data path part 60 of the CPU 1 can continuously process the instructions, and the operating rate of the data path part 60 of the CPU 1 can be improved as compared with that of the prior art.

### Ninth Preferred Embodiment

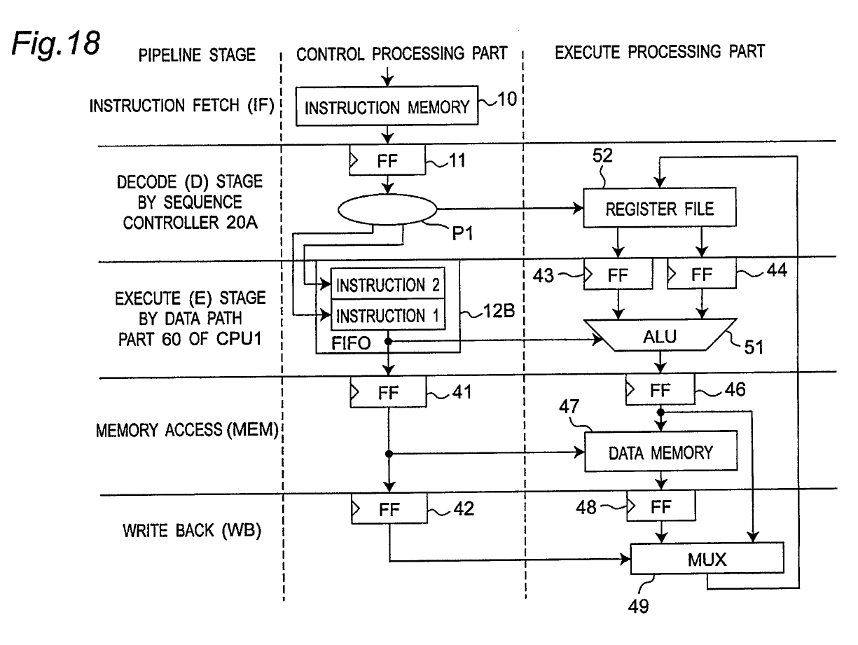

FIG. 18 is a pipeline chart showing a configuration of a processing part of a processor according to the ninth preferred embodiment of the invention. Referring to FIG. 18, such a point of difference resides that the sequence controller 20A is provided in place of sequence controller 20 and the FIFO 12B is provided in place of the asynchronous FIFO 12 as compared with the processor of the seventh preferred embodiment shown in FIG. 16. The other points are similar to those of the processor of the seventh preferred embodiment shown in FIG. 16, and no reiterative explanation is provided for the components denoted by the same reference numerals.

Referring to FIG. 18, the sequence controller 20A is different from the sequence controller 20 of the seventh preferred embodiment only in that the decoded instructions are outputted two by two to the FIFO 12B. The FIFO 12B has a configuration and action or operation similar to those of the FIFO 12B of the processor of the fourth preferred embodiment shown in FIG. 10, and therefore, no description is provided therefor.

As described above, according to the processor of the present preferred embodiment, the FIFO 12B that can inputs two instructions in one cycle is provided between the sequence controller 20A and the data path part 60 of the CPU 1. Therefore, the data path part 60 of the CPU 1 can continuously process the instructions, and the operating rate of the data path part 60 of the CPU 1 can be improved as compared with that of the prior art.

### Tenth Preferred Embodiment

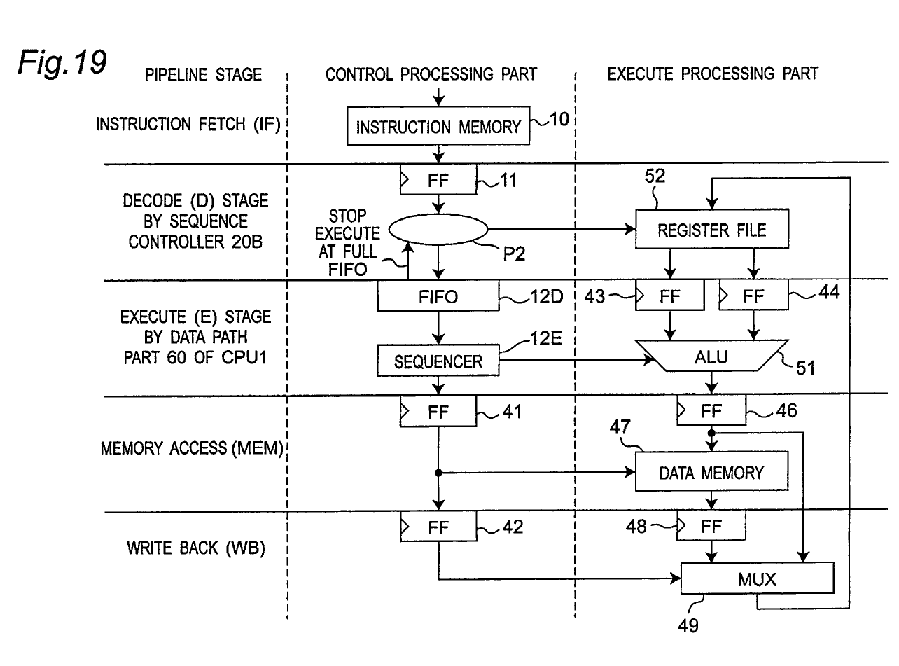

FIG. 19 is a pipeline chart showing a configuration of a processing part of a processor according to the tenth preferred embodiment of the invention. Referring to FIG. 19, such a point of difference resides that the sequence controller 20B is provided in place of the sequence controller 20 and the FIFO 12D and the sequencer 12E are provided in place of the asynchronous FIFO 12 as compared with the processor of the seventh preferred embodiment shown in FIG. 16. The other points are similar to those of the processor of the seventh preferred embodiment shown in FIG. 16, and no reiterative explanation is provided for the components denoted by the same reference numerals.

Referring to FIG. 19, in the decode (D) stage by the sequence controller 20B, the instruction code is decoded into an instruction in a form which can be processed by the sequence controller 20B by carrying out the prescribed processing P2 of the instruction code read out from the instruction memory 10 via the FF 11. The decoded instruction is outputted to the register file 52, and a plurality of instructions is converted into one instruction in a form which can be processed by the sequencer 12E and thereafter outputted. It is noted that the sequencer 12E has a configuration and action or operation similar to those of the sequencer 12E of the processor of the sixth preferred embodiment shown in FIG. 13, and therefore, no description is provided therefor. In this case, when the FIFO 12D holds a prescribed number of instructions, the signal of “FIFO full” is outputted from the FIFO 12D to the sequence controller 20B in a manner similar to that of the sixth preferred embodiment. The FIFO 12D is in the memory full state while the signal is asserted, and no more instruction can be put from the sequence controller 20B into the FIFO 12D. In this case, the sequence controller 20B stops executing the processing P2 and puts no new instruction into the FIFO 12D.

As described above, according to the processor of the present preferred embodiment, the sequencer 12E is provided between the sequence controller 20B and the data path part 60 of the CPU 1, and the sequencer 12E generates the plurality of instructions based on the instructions supplied from the sequence controller 20B and continuously supplies the instructions to the data path part 60 of the CPU 1. Therefore, the data path part 60 of the CPU 1 can continuously process the instructions, and the operating rate of the data path part 60 of the CPU 1 can be improved as compared with that of the prior art.

### Eleventh Preferred Embodiment

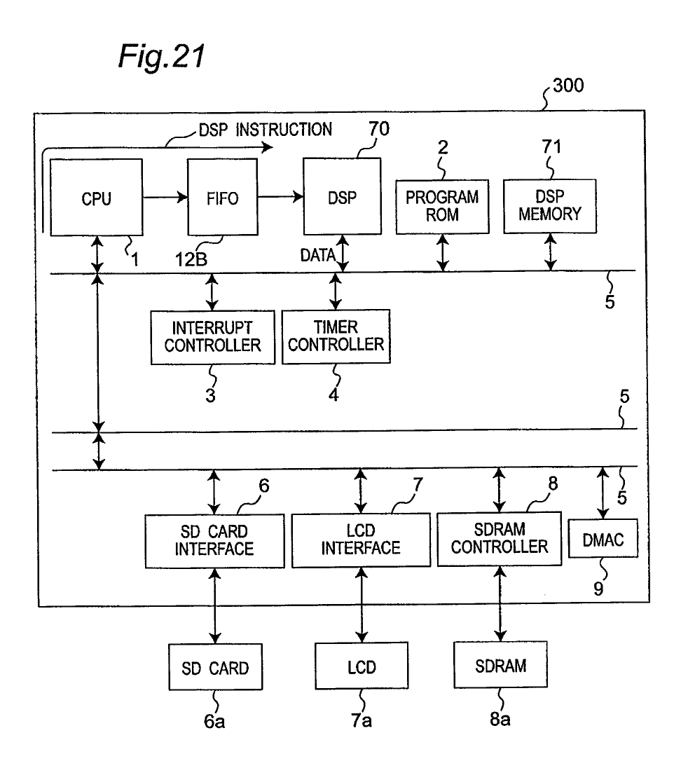

FIG. 21 is a block diagram showing a configuration of a processor 300 according to the eleventh preferred embodiment of the invention. Referring to FIG. 21, the processor 300 is characterized in that a digital signal processor (DSP) 70 and a DSP memory 71 that stores an execution program of the DSP 70 are provided in place of the sequence controller 10 and the operation array 21 as compared with the processor 200C of the fourth preferred embodiment of FIG. 9. Referring to FIG. 21, the operation of the DSP 70 is executed by the CPU 1, and the operation of the operation array 21 is executed by the DSP 70. In this case, the DSP instruction is supplied from the CPU 1 via the FIFO 12B and executed by the DSP 70, while the operation data are transferred between the DSP memory 71 and the DSP 70 via the bus 5.

In the present preferred embodiment, the FIFO 12B is provided between the CPU 1 and the DSP 70. Therefore, the number of cycles of the single operation of the CPU 1 can be reduced by setting the operating frequency of the CPU 1 to be higher than the operating frequency of the DSP 70, while the DSP 70 can continuously process the instructions, and this leads to that the operating rate of the DSP 70 can be improved as compared with that of the prior art.

### Twelfth Preferred Embodiment

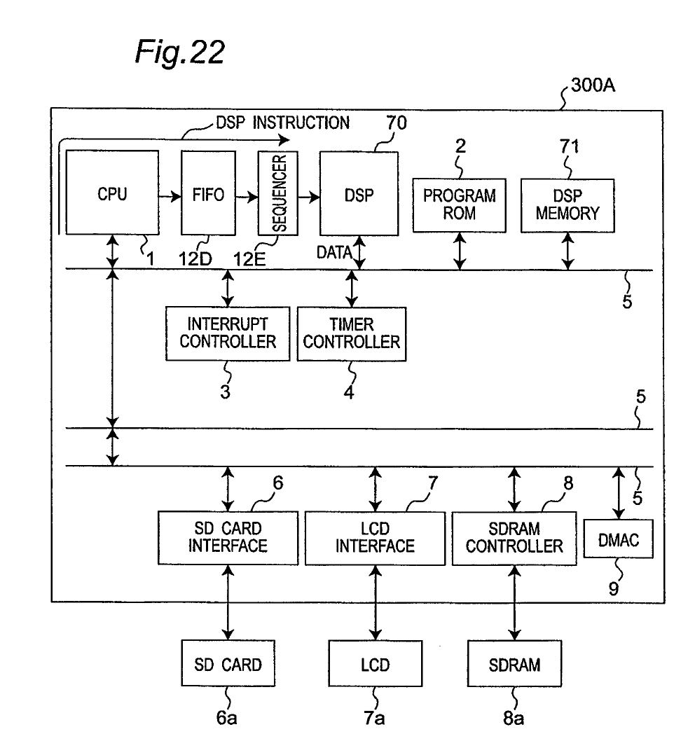

FIG. 22 is a block diagram showing a configuration of a processor 300A according to the twelfth preferred embodiment of the invention. Referring to FIG. 22, the processor 300A is characterized in that the FIFO 12D and the sequencer 12E are provided in place of the FIFO 12B in a manner similar to that of the sixth preferred embodiment of FIG. 13 as compared with the processor 300 of the eleventh preferred embodiment of FIG. 21. Referring to FIG. 22, the operation of the sequence controller 10 is executed by the CPU 1, and the operation of the operation array 21 is executed by the DSP 70. In this case, the DSP instruction is supplied from the CPU 1 via the FIFO 12D and the sequencer 12E and executed by the DSP 70, while the data are transferred between the CPU 1 and the DSP 70 via the bus 5.

In the present preferred embodiment, the FIFO 12D and the sequencer 12E are provided between the CPU 1 and the DSP 70. Therefore, the sequencer 12E itself supplies instructions to the DSP 70, and the DSP 70 autonomously carries out the arithmetic processing over a plurality of cycles. Therefore, it becomes possible to issue the next processing of the DSP 70 and to execute the processing singly by the CPU 1 during the time. The CPU 1 and the DSP 70 can operate in parallel, and the number of cycles of the single operation of the CPU 1 is reduced, and this leads to increase in the operating rate of the DSP 70.

### INDUSTRIAL APPLICABILITY

As described in detail above, according to the processor apparatus of the invention, the processor apparatus includes the sequence controller that decodes the instruction code stored in the instruction memory and the operation part that executes operation of the decoded instruction code, and further includes the operation controller provided between the decode stage for decoding the instruction code into at least one instruction by the sequence controller and the execute stage for executing the decoded instruction by the operation part. The operation controller executes control, so that the read timing and the execute timing of the decoded instruction are different from each other, and the decoded instruction is continuously executed by the operation part. In this case, the operation controller such as an asynchronous FIFO is provided between the sequence controller and the operation part of the processor apparatus, and carrying out parallel operation of the sequence controller and the operation part. Then the operating rate of the operation part is thereby increased, and the performance of the entire processor apparatus can be improved by reducing the number of execute cycles.

The invention can be utilized generally for processors, and in particular, can be utilized for the processor that includes a digital signal processing circuit for carrying out bit serial operation and its system.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A processor apparatus comprising a sequence controller for decoding an instruction code stored in an instruction memory, and an operation part for executing operation of the decoded instruction code, the processor unit further comprising:
an operation controller provided between a decode stage for decoding the instruction code into at least one instruction by the sequence controller and an execute stage for executing the decoded instruction by the operation part, the operation controller executing control so that a read timing and an execute timing of the decoded instruction are different from each other, and the decoded instruction is continuously executed by the operation part.

2. The processor apparatus as claimed in claim 1,
wherein the operation controller comprises an asynchronous FIFO which is set so that an operating frequency of the sequence controller becomes higher than an operating frequency of the operation part.

3. The processor apparatus as claimed in claim 1,
wherein the operation controller comprises a memory,
wherein the sequence controller temporarily stores the decoded instruction into the memory, and
wherein the operation part continuously reads out and executes the instruction stored in the memory.

4. The processor apparatus as claimed in claim 3, further comprising a direct memory access controller for transferring the instruction stored in the memory to the operation part by a direct memory access,
wherein the sequence controller, the operation part, the direct memory access controller and the memory are connected via a bus with each other.

5. The processor apparatus as claimed in claim 1,
wherein the operation controller comprises a FIFO for inputting a plurality of decoded instructions in one cycle, and outputting the inputted instructions sequentially continuously to the operation part.

6. The processor apparatus as claimed in claim 1,
wherein the operation controller comprises a programmable logic controller for generating a plurality of instructions on the basis of the decoded instruction, and outputting the generated instructions sequentially and continuously to the operation part.

7. The processor apparatus as claimed in claim 6,
wherein the programmable logic controller is a sequencer.

8. The processor apparatus as claimed in claim 1,
wherein the processor apparatus is a SIMD processor apparatus.

9. The processor apparatus as claimed in claim 1,
wherein the operation part is a data path portion of a CPU.

10. The processor apparatus as claimed in claim 5,
wherein the operation part is a digital signal processor (DSP).

11. The processor apparatus as claimed in claim 8,
wherein the operation part is a plurality of processing elements (PEs).
